(19) United States
(12) Patent Application Publication
(10) Pub. No.: US 2016/0305498 A1
(43) Pub. Date: Oct. 20, 2016

(54) BRAKE DISCS

(71) Applicant: Eurac Limited, Poole (GB)

(72) Inventor: David Eggleston, Wimborne (GB)

(21) Appl. No.: 15/098,045

(22) Filed: Apr. 13, 2016

(30) Foreign Application Priority Data
Apr. 15, 2015 (GB) 15 06 523.8

(51) Int. Cl. F16D 65/12; B22D 19/16

(52) U.S. Cl. CPC F16D 65/125; F16D 65/123; B22D 19/16; F16D 2065/1344

(57) ABSTRACT

A brake disc (401) for a vehicle is shown. The brake disc has a hub (403) to be secured to a wheel or an axle of a vehicle, such that it will rotate about an axis (B). The brake disc also has a brake member (402) comprising an annular friction ring (501) having an inner radius (503) and an outer radius (504), and an axially extending hollow cylindrical flange (502) having an inner surface and an outer surface. The hub is a casting which extends over both the inner surface and the outer surface of the flange. The hub is formed of a first material and the friction ring is formed of a second material, and the first material has a lower density, a lower melting point, and a higher coefficient of linear thermal expansion than the second material.

### CROSS REFERENCE TO RELATED APPLICATIONS

This application claims priority from United Kingdom Patent Application No. 15 06 523.8, filed 15 Apr. 2015, the entire disclosure of which is incorporated herein by reference in its entirety.

### BACKGROUND OF THE INVENTION

The present invention relates to brake discs for vehicles:

A brake disc of a vehicle comprises a friction ring that rotates with a ground-engaging wheel of the vehicle and is gripped by caliper-operated pads to slow the vehicle down when required. The friction ring must be able to resist both wear from the brake pads and heat generated by the braking. For these reasons friction rings are conventionally made of cast iron.

However, as is well known, cast iron is a relatively heavy material for use in a sports car: it is, for instance, about two and a half times as heavy as aluminum. Therefore, to reduce the weight of the disc brake as a whole, the friction ring may be carried on a hub formed of lighter material such as aluminum or an aluminum alloy. The hub, sometimes known as a “top hat”, is in use connected to the ground-engaging wheel or an axle of the wheel.

This so-called “composite” form of construction (which should not be confused with the possible use of fiber-reinforced plastics materials) contrasts with monolithic forms in which the friction ring and the hub are integrally formed from the same material in that it requires a connection between the hub and the friction ring that will withstand both rotational forces in braking (and acceleration) and transverse forces in cornering. Various kinds of such connection have been previously proposed.

For example a friction ring of cast iron may be connected to a substantially lighter cast light-aluminum or deep-drawn sheet-steel brake-disc hub. Spigots on the friction ring engage in associated recesses in the hub to transmit rotational forces and a retaining ring secures the joint against transverse (axial) forces, but additional screw connections are also recommended.

However, the retaining ring and screw connections necessarily add to the complexity of such an arrangement. A simpler arrangement is to cast the hub on to the friction ring whereby the friction ring and the hub are formed with castellations mutually intercalated in the plane of the friction ring. The castellations may additionally be formed with bevels and steps that can increase the strength of the connection between the hub and the friction ring.

### BRIEF SUMMARY OF THE INVENTION

According to an aspect of the present invention, there is provided a brake disc for a vehicle, which brake disc comprises:

a hub securable to a wheel or an axle of the vehicle for rotation therewith about an axis; and

a brake member comprising an annular friction ring having an inner radius and an outer radius, and an axially extending hollow cylindrical flange having an inner surface and an outer surface; wherein:

the hub is formed of a first material and the friction ring is formed of a second material, and the first material has a lower density, a lower melting point, and a higher coefficient of linear thermal expansion than the second material; and

the hub is a casting which extends over the inner surface and the outer surface of the flange.

According to another aspect of the present invention, there is provided a method comprising manufacturing a brake disc having a hub of a first material and a brake member of a second material, said method comprising the steps of:

selecting a first material that has a lower density, a lower melting point, and a higher coefficient of linear thermal expansion than the second material;

pre-forming the brake member as an annular friction ring extending in a plane between an inner radius and an outer radius with a hollow cylindrical flange extending orthogonally to the plane of the friction ring;

providing a mold having a cavity configured to receive the flange of the preformed brake member, wherein the cavity has the shape of the hub;

locating the pre-formed brake member so that the flange is received in the cavity; and

casting the hub by delivering the first material in a molten state into the cavity to fill it and engage the flange, and allowing the first material to cool and solidify in the mold,

### BRIEF DESCRIPTION OF THE DRAWINGS

FIG. 1 shows a prior art brake disc 101;

FIG. 2A is a side elevation of the prior art brake disc 101;

FIG. 2B is a vertical cross section of the prior art brake disc 101;

FIG. 3 is a cross section at W-W of FIG. 2A of the prior art brake disc 101;

FIG. 4 illustrates a brake disc 401 according to the present invention;

FIG. 5A is a side elevation of the brake disc 401;

FIG. 5B is a vertical cross section of the brake disc 401;

FIG. 6 is a cross section at X-X of FIG. 5A showing the brake disc 401;

FIG. 7 is a vertical cross section of the brake disc 401 including also a circumferential channel 701;

FIG. 8 is a vertical cross section of brake disc 401 including also a hub casting 801 that extends through the brake member 402 and axially outwards;

FIG. 9 is a vertical cross section of the brake disc 401 including also radially extending nubs 901 and 902; and

FIG. 10 is a cross section at Y-Y of FIG. 9 showing the radially extending nubs 901 and 902;

FIG. 11 is a vertical cross section of the brake disc 401 including also holes 1101 and 1102; and

FIG. 12 is a cross section at Z-Z of FIG. 11 showing holes 1101 and 1102.

### DETAILED DESCRIPTION OF THE INVENTION

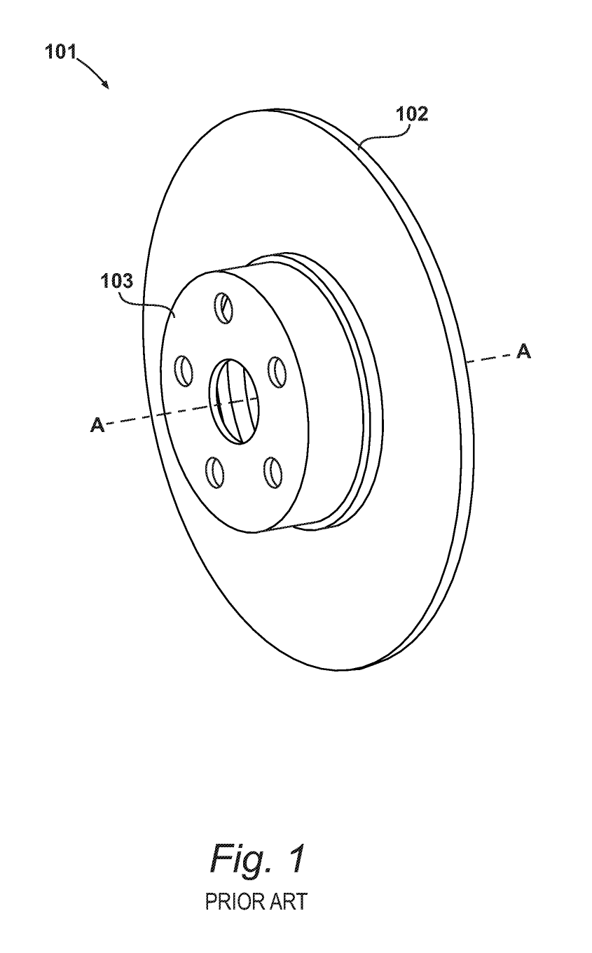

### FIG. 1

A brake disc 101 of the prior art is shown in FIGS. 1 to 4.

The brake disc 101 comprises a friction ring 102 made of cast iron and a hub 103 made of cast aluminum alloy for connection to a road wheel or an axle of a vehicle (not shown). The friction ring 102 is annular about an axis A, which, when fitted to a vehicle, is the axis of rotation of the road wheel or axle.

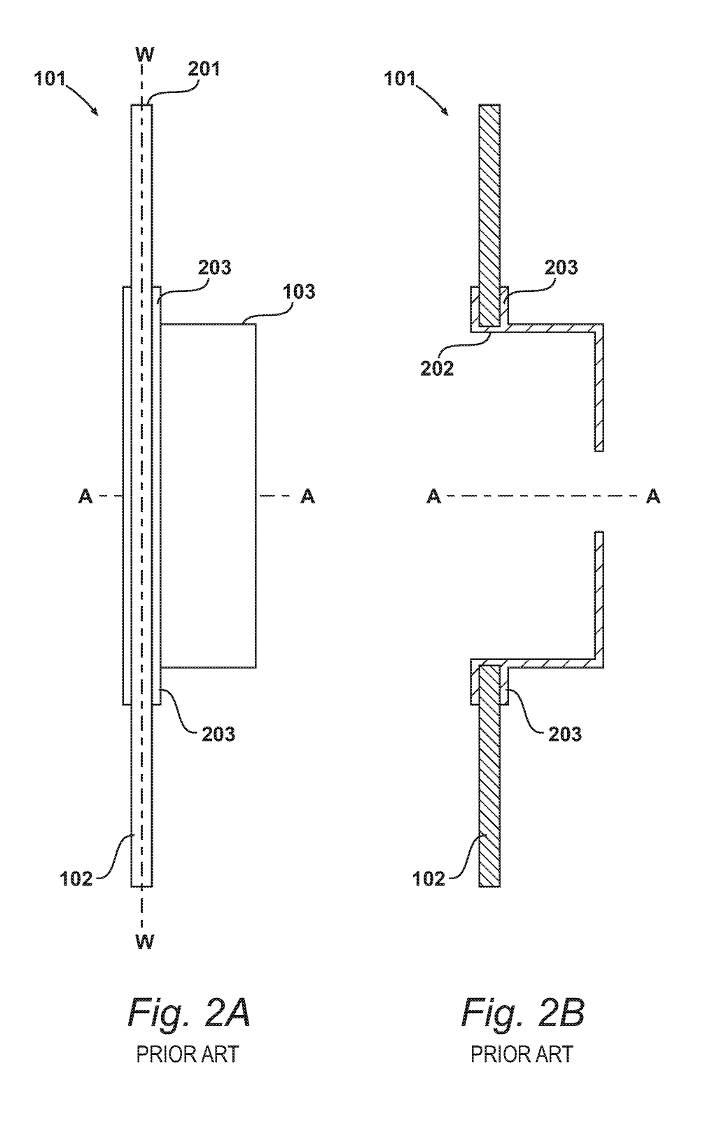

### FIGS. 2A & 2B

The brake disc 101 is shown in side elevation in FIG. 2A, and in vertical cross section through its axis A in FIG. 2B.

The brake disc 101 has an inner radius 201 defined by the friction ring 102, and an outer radius 202 defined by the hub 103. The hub 103 is cast on to the friction ring 102, and has a radially extending flange 203 cast over the horizontally inner margins of the friction ring 102.

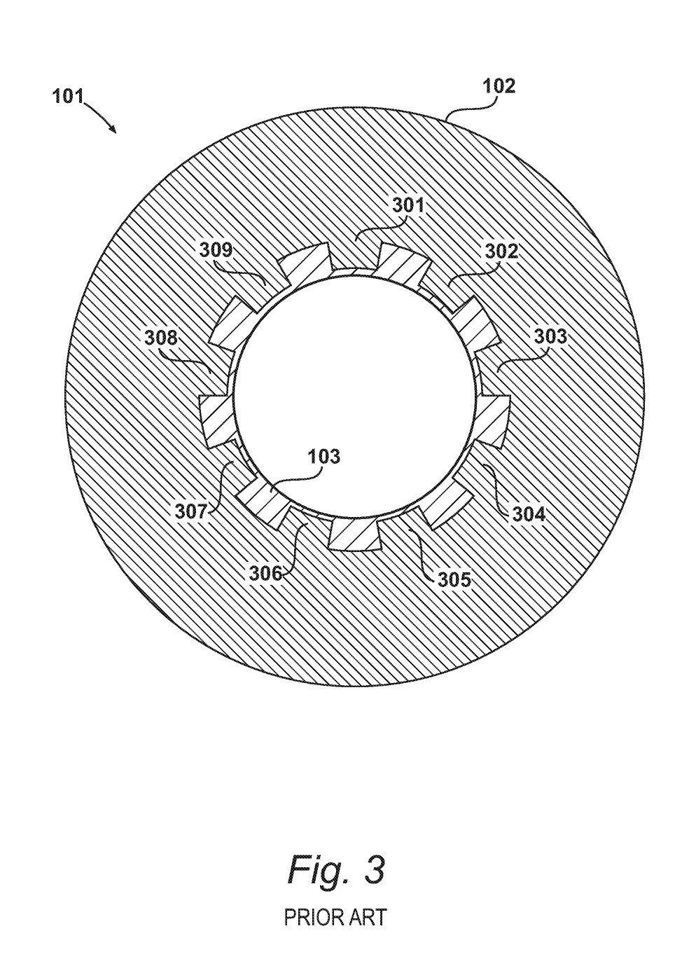

### FIG. 3

A cross sectional view of the brake disc 101 is shown in FIG. 3, along the line W-W identified in FIG. 2A.

As shown in FIG. 3, the friction ring 102 is formed with inwardly directed castellations 301, 302, 303, 304, 305, 306, 307, 308, and 309 with spaces between them that are filled by the aluminum alloy when the hub 103 is cast. It will be appreciated that, for simplicity of illustration, only a few castellations 301 to 309 are shown in FIG. 3, and in practice there may be more.

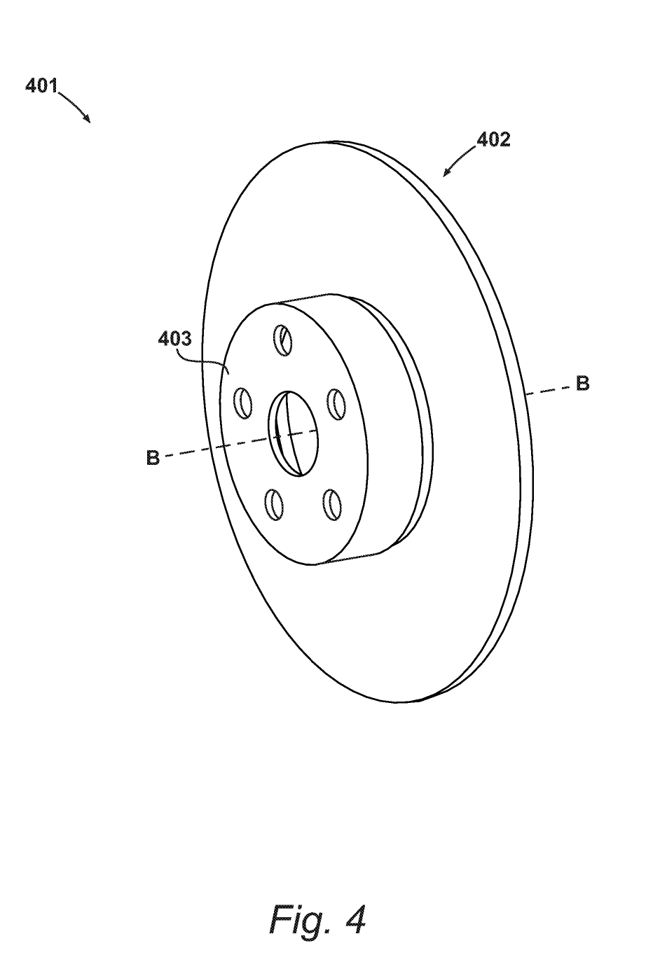

### FIG. 4

A brake disc 401 according to the present invention is illustrated in FIG. 4, which in the present embodiment is a solid disc brake for fitting to a passenger vehicle. However, it will be appreciated by those skilled in the art that the principles of the present invention may be extended to ventilated disc brakes targeted at high performance applications.

The brake disc 401 has a brake member 402 annular around an axis B (the axis of rotation of a road wheel or axle, not shown, as with brake disc 101), and a hub 403.

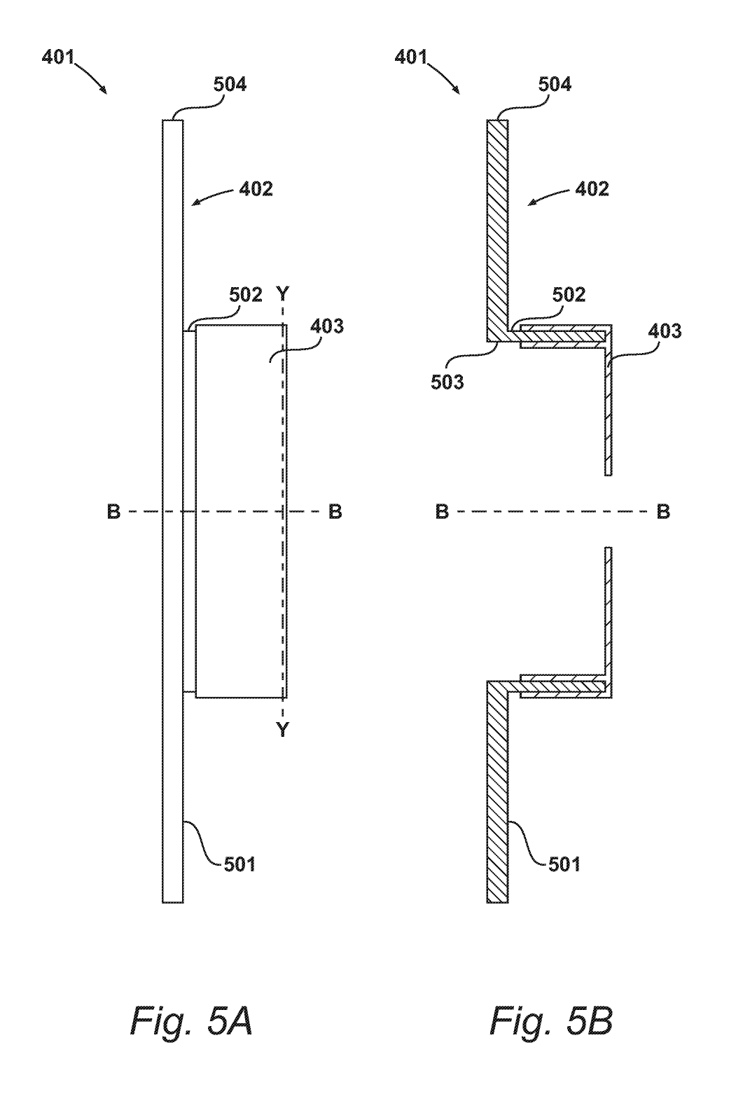

### FIGS. 5A & 5B

The brake disc 401 is shown in an end-on view in FIG. 5A, and in cross section through its axis B in FIG. 5B, In particular, the differences between the present invention and the prior art brake disc 101 described with reference to FIGS. 1 to 4 are shown.

The brake member 402 comprises a friction ring 501 annular about axis B. The friction ring 501 extends radially in a plane from an inner radius 503 to an outer radius 504. The brake member further comprises a hollow cylindrical flange 502 extending axially from the friction ring 501 (i.e. orthogonally from its plane). The inner radius 503 of the friction ring 501 is coterminous with the inside surface of the hollow cylindrical flange 502.

The hub 403 extends axially over both the inner surface and the outer surface of the flange 502. That is to say, the hub 403 engages radially opposed surfaces of the flange 502 and thereby makes a connection between the hub 403 and the brake member 402.

It should be noted that the radial flange 203 of the prior art brake disc 101 is necessarily limited in extent because of the need to leave enough of the friction ring 102 clear for the brake pads (not shown). This in turn limits the strength of the cast-on engagement between the prior art hub 103 and the prior art friction ring 102. By contrast, in the brake disc 401 of the present invention, the hub 403 is cast on to the axially extending flange 502 which does not have such a limitation in extent. Thus the brake disc 401 according to the present invention has much improved strength over the prior art brake disc 101.

Referring again to FIG. 5A, the hub 403 of brake disc 401 is formed of a first material, and the brake member 402 is formed of a second material. In the present embodiment, the first material is selected so that it has a lower density, a lower melting point, and a higher coefficient of linear thermal expansion relative to the second material.

In an embodiment, the first material is iron or an alloy thereof, with the second material being selected so the above properties are satisfied. In another embodiment, the second material is aluminum, or an alloy thereof, with the first material being selected so the above properties are satisfied. In a specific embodiment, the first material is iron or an alloy thereof, and the second material is aluminum or an alloy thereof.

In practice, following selection of the first and second materials in accordance with the above constraints, the brake disc 401 of the present invention is manufactured by first pre-forming the brake member 402 using the selected second material. In the present embodiment, this is achieved in an embodiment by casting the brake member 402, such that the friction ring 501 and the flange 502 are integrally formed. The brake member 402 may then be machined it, Alternatively, the brake member 402 may be created by coupling a separately-cast friction ring 501 and flange 502 together in a known manner.

The brake member 402 is then located in a mold having a cavity for the flange 502. The hub 403 is then cast onto the flange by delivering molten first material into the cavity to fill and engage with the flange. The hub 403 is then allowed to cool and solidify in the mold. Optionally, the brake member 402 may be heated prior to delivery of the first material to improve the interface between the materials, and reduce any thermal shock caused by the addition of molten second material.

Those skilled in the art will appreciate that after the hub 403 has been cast on to the flange 502, the brake disc 401 comprising the hub 403 plus brake member 402 can be subject as a whole to further machining before it is fitted to a vehicle,

The effect of selecting a first material which has a lower density than the second material is to reduce the overall weight of the brake disc 401, and thereby assist in reduction of unsprung weight, improving vehicle performance and fuel economy.

The effect of selecting a first material which has a lower melting point than the second material is to allow it to be cast onto the pre-formed brake member 402.

The effect of selecting a first material which has a higher coefficient of linear thermal expansion than the second material is to provide a better (and better protected) joint between the hub 403 and the brake member 402. As will be appreciated by those skilled in the art, the interface between two materials of differing electrode potential is liable to galvanic corrosion in the presence of an electrolyte, such as is the case when, for example, an aluminum alloy is cast on to grey cast iron.

In the present invention, the second material of the hub 403 is specifically selected to have a higher coefficient of linear thermal expansion than the second material of the brake member 402. Thus, during manufacture, the hub 403 contracts more than the flange 502 as it cools after being cast. This, in combination with the hub 403 being arranged to extend over both the outer and inner surfaces of the flange 502, results in a tighter joint between the hub 403 and the flange 502 being formed.

Not only does this result in a stronger joint that can be subjected to greater axial forces, it also results in an interface between the first material and second material that is better protected against the ingress of moisture which could function as an electrolyte and thereby give rise to galvanic corrosion.

By contrast, the principal shrinkage of the prior art hub 103 after casting will be away from the inner radius 503 of the friction ring 102. This may cause weakening of the connection between the prior art hub 103 and the prior art friction ring 102 and hence a greater risk of moisture penetration and galvanic corrosion in use.

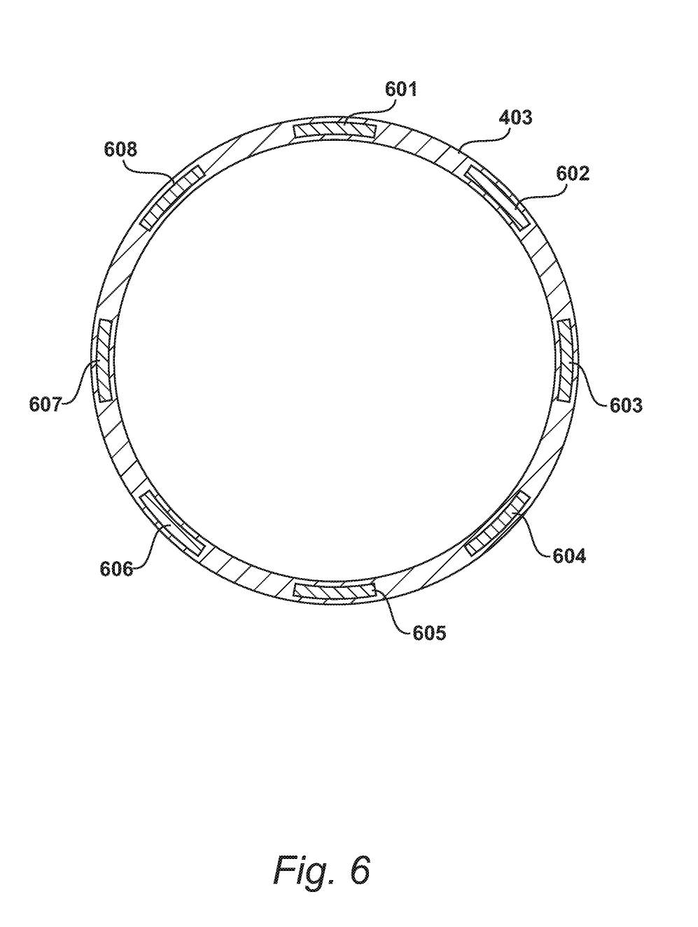

### FIG. 6

A cross sectional view of the brake disc 401 is shown in FIG. 6, along the line X-X identified in FIG. 5A.

As illustrated in FIG. 6, in the present embodiment the flange 502 is formed with axially-directed castellations 601, 602, 603, 604, 605, 606, 607, and 608 encapsulated in the casting of the hub 403. It will be appreciated that for simplicity of illustration, only a few castellations 601 to 608 are shown in FIG. 6, and in practice there may be more.

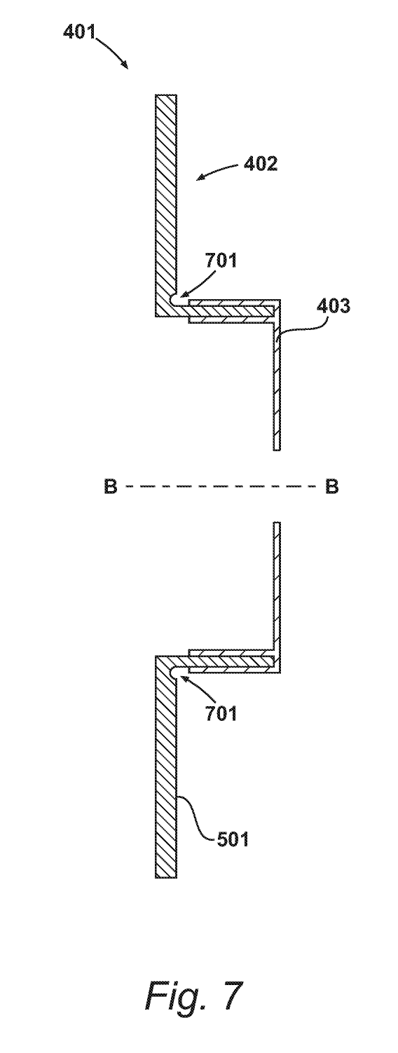

### FIG. 7

Various additional features may be provided on the brake disc 401 to improve the general performance disc, and also improve the interface between the brake member 402 and the hub 403.

First, an embodiment of the brake disc 401 is shown in FIG. 7 in which a circumferential channel 701 is provided at the join of the friction ring 501 and the flange 502. The inclusion of the circumferential channel 701 has been shown to reduce coning, which is a conical deformation of the friction ring 501 which acts to force the brake pads apart slightly, thereby changing the pressure distribution of the pad and reducing braking effectiveness.

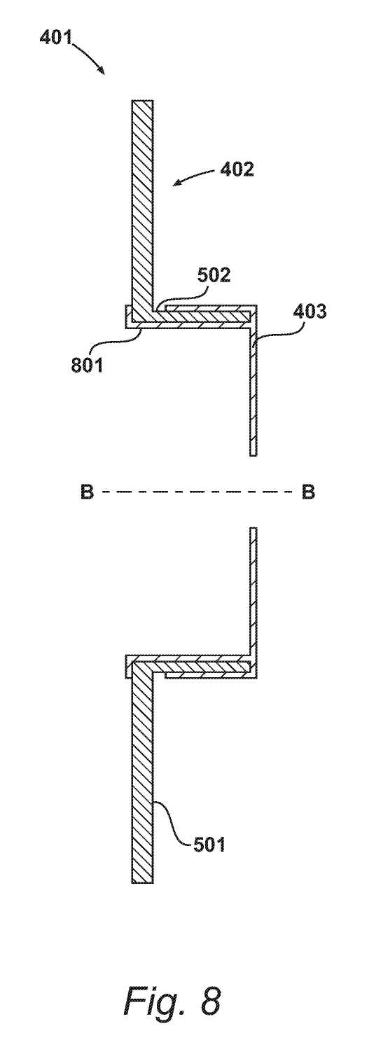

### FIG. 8

Second, an embodiment of the brake disc 401 is shown in FIG. 8 in which the casting of the hub 403 extends axially at 801 over the whole of the inside of the flange 502, through the inner radius of the friction ring 501 and radially outwards by a small amount. This extension of the casting of the hub 403 strengthens the axial connection with the brake member 402, allowing the brake disc 401 to withstand greater axial forces on the brake member 402.

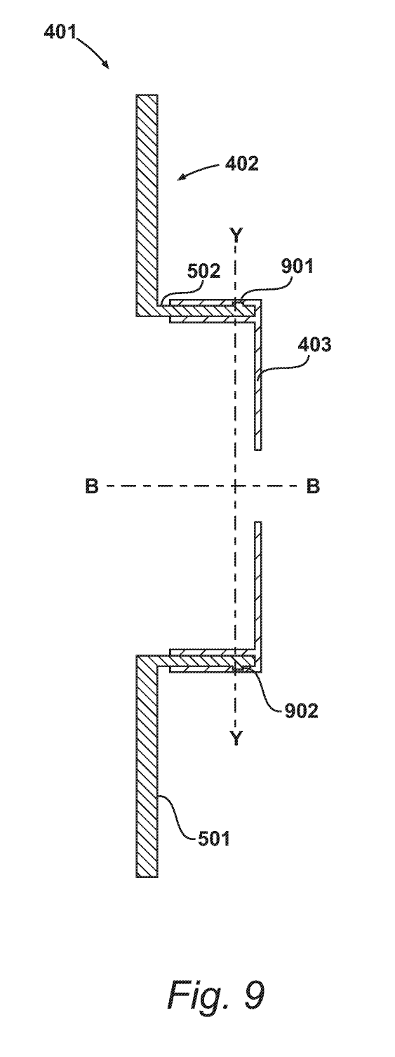

### FIG. 9

Third, an embodiment of the brake disc 401 is shown in FIG. 9 in which the flange 502 is formed with outwardly extending nubs (or lumps) 901 and 902. The nubs 901 and 902 are encapsulated in the casting of the hub 403 to strengthen the circumferential connection. It will be appreciated that for simplicity of illustration, only two nubs 901 and 902 are visible in FIG. 9, but in practice there may be more. In an alternative embodiment, the nubs could be replaced by one single circumferential flange.

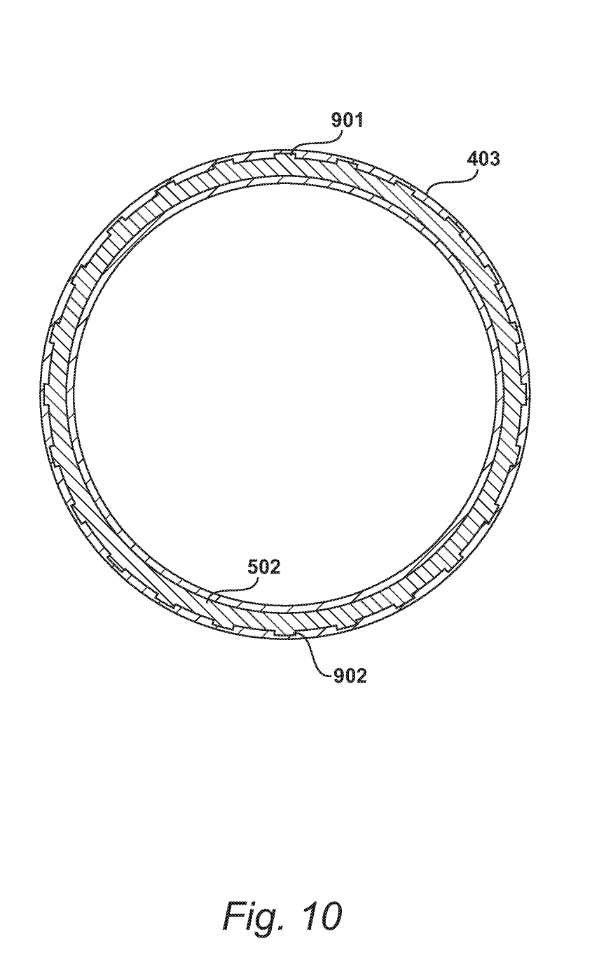

### FIG. 10

A cross sectional view of the brake disc 401 is shown in FIG. 10, along the line Y-Y identified in FIG. 9.

As can be seen, holes 1101 and 1102 extend axially and in the present embodiment, an even radial distribution of holes is included. Thus, during casting the holes 1001 and 1002 are filled with the first material of the hub 403 and strengthen its circumferential connection with the flange 502 of the brake member 402.

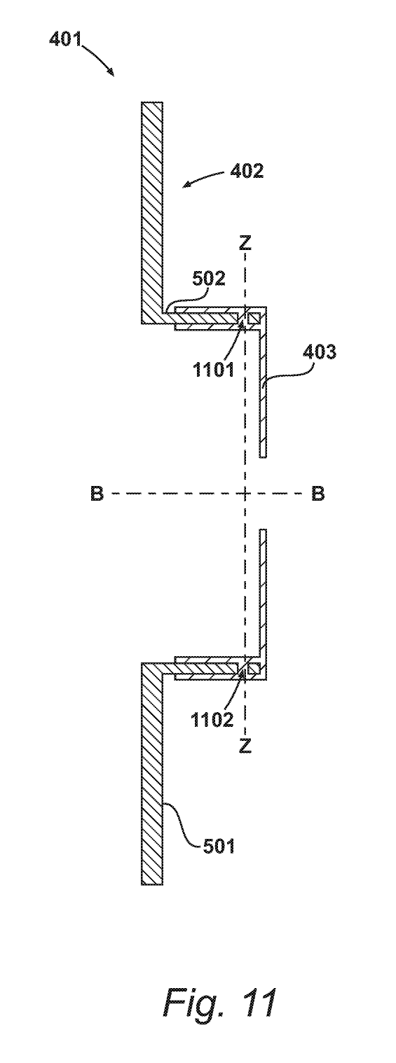

### FIG. 11

Finally, an embodiment of the brake disc 401 is shown in FIG. 11 in which the flange 502 is formed with holes in it, such as holes 1101 and 1102. In an embodiment the holes are formed when casting the brake member 403 by inclusion of appropriate holes in its mold. In an alternative embodiment the holes may be formed during the machining of the brake member 402.

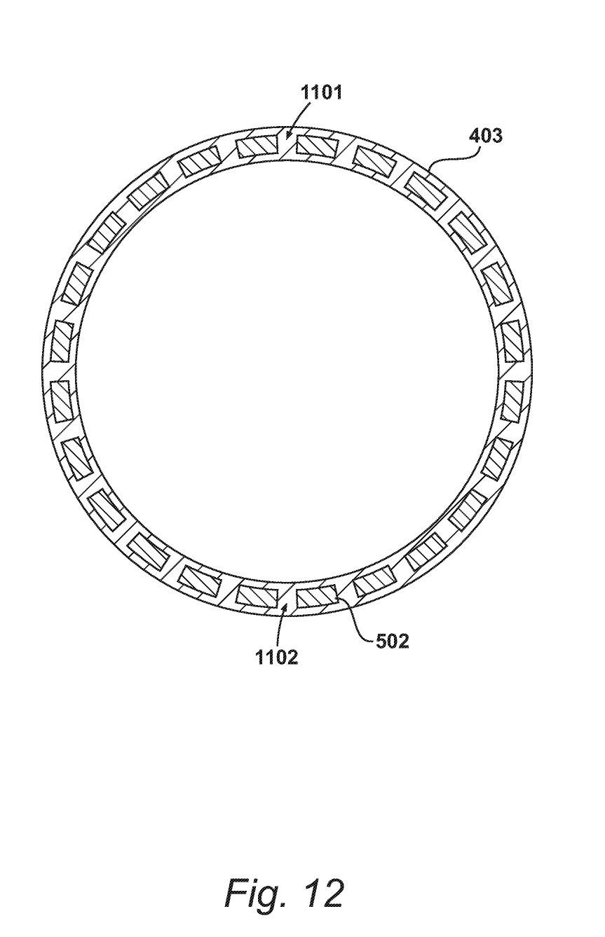

### FIG. 12

A cross sectional view of the brake disc 401 is shown in FIG. 12, along the line Z-Z identified in FIG. 11.

As can be seen, holes 1101 and 1102 extend axially and in the present embodiment, an even radial distribution of holes is included. Thus, during casting the holes 1101 and 1102 are filled with the first material of the hub 403 and strengthen its circumferential connection with the flange 502 of the brake member 402.

In an alternative embodiment, the holes may be substituted for recesses extending only part way through the radial thickness of the flange 502, rather than completely therethrough as holes 1101 and 1102 do. Such recesses may either be recesses in the outer surface of the flange 502 or recesses in its inner surface.

It should be understood that the axial castellations 601 to 608, the circumferential channel 701, the axially extended casting 801, the nubs 901 and 902 (or circumferential flange) and the holes 1101 and 1102 (or recesses) may be used together in any combination.

The invention claimed is:

1. A brake disc for a vehicle, which brake disc comprises:
a hub securable to a wheel or an axle of the vehicle for rotation therewith about an axis; and
a brake member comprising an annular friction ring having an inner radius and an outer radius, and an axially extending hollow cylindrical flange having an inner surface and an outer surface; wherein:
the hub is formed of a first material and the friction ring is formed of a second material, and the first material has a lower density, a lower melting point, and a higher coefficient of linear thermal expansion than the second material; and
the hub is a casting which extends over the inner surface and the outer surface of the flange.

2. A brake disc as claimed in claim 1, wherein the first material comprises aluminum or an alloy thereof.

3. A brake disc as claimed in claim 1, wherein the second material comprises iron or an alloy thereof.

4. A brake disc as claimed in claim 1, wherein the friction ring and the flange are an integrally formed casting.

5. A brake disc as claimed in claim 1, wherein the flange is formed with axially extending castellations.

6. A brake disc as claimed in claim 1, wherein the hub further extends through the inner radius of the friction ring and axially outwards.

7. A brake disc as claimed in a claim 1, wherein the flange includes one or more radially extending nubs which are encapsulated in the casting of the hub.

8. A brake disc as claimed in claim 1, wherein the flange has one or more holes extending radially through the flange, which holes are filled with the first material.

9. A brake disc as claimed in claim 1, wherein the flange has one or more recesses extending radially part way through the flange, which recesses are filled with the first material.

10. A vehicle comprising at least one brake disc as claimed in claim 1.

11. A method comprising manufacturing a brake disc having a hub of a first material and a brake member of a second material, said method comprising the steps of:
selecting a first material that has a lower density, a lower melting point, and a higher coefficient of linear thermal expansion than the second material;
pre-forming the brake member as an annular friction ring extending in a plane between an inner radius and an outer radius with a hollow cylindrical flange extending orthogonally to the plane of the friction ring;
providing a mold having a cavity configured to receive the flange of the preformed brake member, and wherein the cavity has the shape of the hub;
locating the pre-formed brake member so that the flange is received in the cavity; and
casting the hub by delivering the first material in a molten state into the cavity to fill it and engage the flange, and allowing the first material to cool and solidify in the mold.

12. A method of manufacturing a brake disc as claimed in claim 11, wherein the first material is aluminum or an alloy thereof.

13. A method of manufacturing a brake disc as claimed in claim 11, wherein the second material is iron or an alloy thereof.

14. A method of manufacturing a brake disc as claimed in claim 11, wherein the step of pre-forming the brake member comprises casting and machining.

15. A method of manufacturing a brake disc as claimed in claim 14, wherein the casting and machining of the brake member comprises forming at least one of:
axially extending castellations on the flange;
one or more radially extending nubs on the flange to be encapsulated in the casting of the hub;
one or more holes in the flange to be filled by the first material during casting of the hub; and
one or more recesses extending radially part way through the flange to be filled with the first material during casting of the hub.

16. A method of manufacturing a brake disc as claimed in claim 11, further comprising the step of heating the brake member before delivering the first material into the cavity.
